(19) United States
(12) Patent Application Publication
(10) Pub. No.: US 2026/0238584 A1
(43) Pub. Date: Aug. 13, 2026

(54) METHOD AND APPARATUS FOR PLANNING TRAFFIC TRANSMISSION PATH, DEVICE, AND STORAGE MEDIUM

(71) Applicant: Tencent Technology (Shenzhen) Company Limited, Shenzhen (CN)

(72) Inventors: Yuanyuan GONG, Shenzhen (CN); Chunzhi HE, Shenzhen (CN); Yinben XIA, Shenzhen (CN); Xiang LI, Shenzhen (CN); Mingzhuo CHEN, Shenzhen (CN)

(73) Assignee: Tencent Technology (Shenzhen) Company Limited, Shenzhen (CN)

(21) Appl. No.: 19/637,078

(22) Filed: Apr. 2, 2026

Related U.S. Application Data
(63) Continuation of application No. PCT/CN2024/122688, filed on Sep. 30, 2024.

(30) Foreign Application Priority Data
Dec. 29, 2023 (CN) 202311870093.9

(51) Int. Cl. H04L 45/12

(52) U.S. Cl. CPC H04L 45/12

(57) ABSTRACT

A method, apparatus, and computer-readable storage medium for planning a traffic transmission path is provided. The method determines access layer switch (LA) groups to which N task devices belong respectively. Each LA group includes at least one of the task devices. An LA is connected to the at least one of the task devices. N is an integer greater than one. The N task devices belong to at least two LA groups and the N task devices collectively execute the same task. The method further determines, based on the LA groups to which the N task devices belong respectively, a communication traffic ring formed by the N task devices. The communication traffic ring is a closed-loop transmission path formed by sequentially connecting the N task devices communicatively, and task devices belong to the same LA group being communicatively connected with each other in series within the communication traffic ring.

### CROSS REFERENCE TO RELATED APPLICATIONS

This application is a bypass continuation application of International Patent Application No. PCT/CN2024/122688 , filed on September 30, 2024, which claims priority to and is based on Chinese Patent Application No. 202311870093.9, filed on December 29, 2023, the disclosures of which are incorporated herein in their entireties by reference.

### FIELD

The present disclosure relates to the field of communication technologies, and in particular, to a technology for planning a traffic transmission path.

### BACKGROUND

Planning of a traffic transmission path is configured to properly plan for the traffic transmission path to ensure high efficiency and reliability of data transmission between task devices.

In a related art, when a traffic transmission path is planned, a topology affinity solution is usually used. Specifically, for an artificial intelligence (AI) large model task, when allocation is performed for task devices executing the task, the task is preferentially allocated to task devices in the same access layer switch (LA) group. If the task devices involved in the AI large model task all belong to the same LA group, the traffic transmission path is optimal.

However, because a number of LA ports and a number of task devices that can be accessed is limited, any task requires a number of task devices involved in a task exceeds a maximum value that can be accessed by the LA will inevitably generate traffic across LA groups. In other words, a plurality of task devices configured to execute the same task belong to different LA groups. However, how to properly plan a traffic transmission path formed by the plurality of task devices is not considered in the related art. As a result, a problem that the traffic frequently crosses the LA groups occurs when the task devices communicate with each other, and consequently, communication efficiency between the task devices is affected.

### SUMMARY

Provided are a method and an apparatus for planning a traffic transmission path, a device, a storage medium, and a program product, which can properly plan a traffic transmission path and avoid unnecessary traffic transmission across LA groups, thereby improving communication efficiency between task devices. Technical solutions provided in the embodiments of the present disclosure are as follows:

According to an aspect of some embodiments of the present disclosure, a method for planning a traffic transmission path includes determining access layer switch (LA) groups to which N task devices belong respectively, each of the LA groups including at least one of the task devices and an LA connected to the at least one of the task devices, the N task devices belonging to at least two LA groups, the N task devices collectively executing the same task, and N being an integer greater than one; and determining, based on the LA groups to which the N task devices belong respectively, a communication traffic ring formed by the N task devices, the communication traffic ring being a closed-loop transmission path formed by sequentially connecting the N task devices communicatively, and task devices belonging to the same LA group being communicatively connected with each other in series within the communication traffic ring.

According to an aspect of some embodiments of the present disclosure, an apparatus for planning a traffic transmission path includes at least one memory configured to store program code; and at least one processor configured to read the program code and operate as instructed by the program code, the program code including: a first determining code configured to cause at least one of the at least one processor determine access layer switch (LA) groups to which N task devices belong respectively, each of the LA groups comprising at least one of the task devices and an LA connected to the at least one of the task devices, the N task devices belonging to at least two LA groups, the N task devices collectively executing the same task, and N being an integer greater than one; and a first obtaining code configured to cause at least one of the at least one processor determine, based on the LA groups to which the N task devices belong respectively, a communication traffic ring formed by the N task devices, the communication traffic ring being a closed-loop transmission path formed by sequentially connecting the N task devices communicatively, and task devices belonging to the same LA group being communicatively connected with each other in series within the communication traffic ring.

According to an aspect of some embodiments of the present disclosure, a non-transitory computer-readable storage medium, storing computer code which, when executed by at least one processor, causes the at least one processor to at least: determine access layer switch (LA) groups to which N task devices belong respectively, each of the LA groups including at least one of the task devices and an LA connected to the at least one of the task devices, the N task devices belonging to at least two LA groups, the N task devices collectively executing the same task, and N being an integer greater than one; and determine, based on the LA groups to which the N task devices belong respectively, a communication traffic ring formed by the N task devices, the communication traffic ring being a closed-loop transmission path formed by sequentially connecting the N task devices communicatively, and task devices belonging to the same LA group being communicatively connected with each other in series within the communication traffic ring.

The technical solutions provided in the embodiments of the present disclosure at least include the following beneficial effects:

In a process of constructing the communication traffic ring, relative communication positions of the N task devices are properly planned based on the LA groups to which the N task devices belong respectively, the task devices belonging to the same LA group are preferentially communicatively connected with each other in series, and then the closed-loop transmission path is formed by the N task devices as the final communication traffic ring. According to the foregoing method, because the devices in the same LA group are preferentially communicatively connected with each other in series, unnecessary traffic transmission across the LA groups can be avoided when traffic transmission is performed, thereby reducing traffic across the LA groups, and improving communication efficiency between the task devices.

### BRIEF DESCRIPTION OF DRAWINGS

To describe the technical solutions in the embodiments of the present disclosure more clearly, the following briefly describes the accompanying drawings required for describing the embodiments of the present disclosure. The accompanying drawings in the following description show only some embodiments of the present disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a solution implementation environment according to an embodiment.

FIG. 2 is a schematic diagram of traffic transmission based on a ring topology structure according to an embodiment.

FIG. 3 is a flowchart of a method for planning a traffic transmission path according to an embodiment.

FIG. 4 is a schematic diagram of a communication traffic ring including four task devices according to an embodiment.

FIG. 5 is a schematic diagram of a communication traffic ring including four task devices according to another embodiment.

FIG. 6 is a schematic diagram of a task device including a plurality of network interface cards according to an embodiment.

FIG. 7 is a flowchart of a method for planning a traffic transmission path according to another embodiment.

FIG. 8 is a schematic diagram of a method for obtaining a hash value in a cloud environment according to an embodiment.

FIG. 9 is a schematic diagram of an experimental result of comparing ratios of traffic across LA groups according to an embodiment.

FIG. 10 is a schematic diagram of an experimental result of comparing AllReduce performance according to an embodiment.

FIG. 11 is a block diagram of an apparatus for planning a traffic transmission path according to an embodiment.

FIG. 12 is a block diagram of a structure of a computer device according to an embodiment.

### DETAILED DESCRIPTION

To make the objectives, technical solutions, and advantages of the present disclosure clearer and more comprehensible, implementations of the present disclosure are further described in detail with reference to the accompanying drawings. The described embodiments are not to be construed as a limitation to the present disclosure. All other embodiments obtained by a person of ordinary skill in the art without creative efforts shall fall within the protection scope of the present disclosure.

For ease of understanding the technical solutions provided in the present disclosure, related terms are described below.

Terms used in the implementations of present disclosure are merely intended for explaining the embodiments of the present disclosure but not to limit the present disclosure.

Terms such as “comprising,” “having,” “including,” and “containing” are to be construed as open-ended (meaning “including, but not limited to”) unless otherwise noted. These terms specify the presence of stated features, numbers, steps, operations, elements, components, or combinations thereof, but do not preclude the presence or addition of other features, numbers, steps, operations, elements, components, or combinations thereof.

The term “corresponding to” may refer to (i) a direct correspondence or an indirect correspondence between two objects, (ii) an association relationship between two objects, (iii) a relationship of indicating and being indicated, or (iv) a relationship of configuring and being configured.

The term "indicate" may refer to a direct indication, an indirect indication, or an association relationship. For example, “A indicates B” may mean: (i) A directly indicates B, or B may be obtained using A; (ii) A indirectly indicates B, for example, when A indicates C, and B may be obtained using C; or (iii) A and B have an association relationship.

The term "when" may be interpreted as "in a case that", "if", "during", "in response to", or similar descriptions. Similarly, depending on the context, the phrase "if determining" or "if detecting (a stated condition or event)" may be interpreted as "when determining", "in response to determining", "when detecting (the stated condition or event)", "in response to detecting (the stated condition or event)", or similar descriptions. The terms "first", "second", "third", "fourth", "A^{th}", "B^{th}", and the like are intended to distinguish between different objects, but not to describe a specific sequence.

The terms "include", "have", and any variants thereof are intended to cover a non-exclusive inclusion.

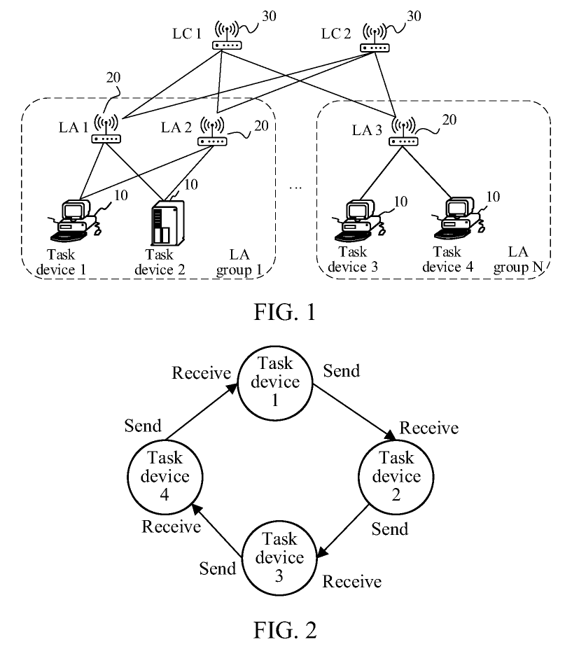

FIG. 1 is a schematic diagram of a solution implementation environment according to an embodiment of the present disclosure. The solution implementation environment may include at least two task devices 10, at least two LAs 20, and at least one layer convergence switch (LC) 30, e.g., LC1 and LC2.

In some embodiments, the task device 10 may be an electronic device such as a personal computer (PC), and a server. The server may be a standalone physical server, or may be a server cluster or a distributed system including a plurality of physical servers, or may be a cloud server providing fundamental cloud computing services such as a cloud service, a cloud database, cloud computing, a cloud function, cloud storage, a network service, cloud communication, a middleware service, a domain name service, a security service, a content delivery network (CDN), along with big data and an artificial intelligence platform.

In some embodiments, the task devices 10 communicate with each other in a ring-based manner. Communicating with each other refers to that data transmission is performed between the task devices 10. Specifically, at least two task devices 10 involved in an AI large model task are connected end to end in traffic interaction to form a ring. The ring is also referred to as a communication traffic ring; in other words, interaction traffic between the task devices 10 is transmitted through a ring topology structure. Each task device 10 has only one left neighbor, and one right neighbor, and the device receives data from its left neighbor and sends data to its right neighbor. For example, as shown in FIG. 2, assume that an AI large model task involves four task devices, namely task device 1, task device 2, task device 3, and task device 4. The four task devices communicate with each other in a ring-based manner, and the task devices are connected end to end in traffic interaction to form a ring. The task device 1 may only receive data from its left neighbor, the task device 4, and send data to its right neighbor, the task device 2.

In some embodiments, each task device 10 may access one or more LAs, each LA may be connected to one or more task devices, and each LA may access to one or more LCs. This is not limited in the present disclosure.

In some embodiments, when any two task devices 10 belong to the same LA group, the any two task devices 10 can communicate with each other by using an LA 20 connected to the two devices. For example, as shown in FIG. 1, the task device 1 and the task device 2 belong to the same LA group. The task device 1 and the task device 2 can communicate with each other by using an LA 1 or an LA 2. This is not limited in the present disclosure.

In some embodiments, when any two task devices 10 does not belong to the same LA group, traffic transmission across the LA groups is needed to be performed on the any two task devices, so that the any two task devices 10 can communicate with each other by using the LA and LC connected to the two devices. For example, as shown in FIG. 1, the task device 1 and task device 2 can communicate with each other by using an LA 1, LC 1, and LA 3, or an LA 2, LC 2, and LA 3. This is not limited in the present disclosure.

In some embodiments, technical solutions provided in the present disclosure may be applied to a parallel execution scenario of an artificial intelligence model. To be specific, at least two task devices 10 collectively execute the same AI large model task, thereby improving calculation efficiency, increasing system fault tolerance, shortening training time, and reducing communication overheads.

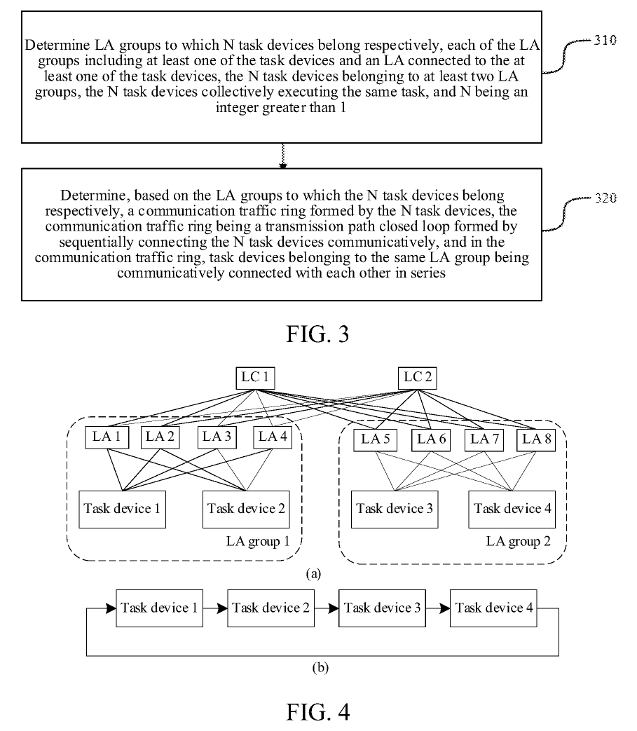

FIG. 3 is a flowchart of a method for planning a traffic transmission path according to an embodiment of the present disclosure. An execution body of each operation of this method may be a computer device. For example, the computer device may be the task device 10 in the solution implementation environment shown in FIG. 1. The method may include the following operation 310 and operation 320.

S310: Determine LA groups to which N task devices belong respectively, each of the LA groups including at least one of the task devices and an LA connected to the at least one of the task devices, the N task devices belonging to at least two LA groups, the N task devices collectively executing the same task, and N being an integer greater than 1.

For example, the foregoing N task devices may collectively execute an AI large model task. The AI large model task refers to an artificial intelligence algorithm or a task that requires a large amount of calculation and processing. Generally, this task requires a large amount of data processing, calculation, training, and optimization, and support of powerful calculation and storage resources is required. To improve execution efficiency and performance of the task, the AI large model task may be allocated to the N task devices for execution. In this way, a calculation capability of each task device can be fully used, so that a task processing speed is improved, and a burden of a single task device is reduced.

The AI large model task is allocated to the N task devices for parallel execution. In a parallel execution process, data interaction and cooperative processing, such as message transfer and data transmission, need to be performed between the task devices. The N task devices transfer data, share a calculation result, and synchronize an execution state with each other, so that effective allocation and cooperative processing of the task can be implemented. Therefore, the execution efficiency and performance of the AI large model can be improved.

Certainly, during actual application, in addition to collectively executing the AI large model, the foregoing N task devices may alternatively be configured to collectively execute another task that needs to consume a large quantity of calculation resources. The task collectively executed by the N task devices is not limited herein in the embodiment of the present disclosure.

The task device is a device that participates in task execution and has a calculation or execution capability. The LA may be configured to communicate between the task devices. The LA is a part of a local area network (LAN). The LA provides functions of data exchange, forwarding, and distribution, thereby allowing communication and data transmission between the task devices. For at least two task devices connected to the same LA, the task devices may communicate directly with each other by using the LA without relying on a network device at another level. The LA can implement the data transmission between the task devices by forwarding a data packet based on a media access control (MAC) address of a target task device or other identification information of the target task device. The target task device herein refers to a recipient of the data packet, in other words, a task device receiving the data packet.

The LA group is a set including the task devices and the LAs connected to the task devices, and may be used as a unit in a network architecture. Each of the LA groups includes at least one of the task devices and the LA connected to the at least one of the task devices. As shown in FIG. 4, for example, an LA group 1 includes task device 1 and task device 2, as well as access layer switches LA 1, LA 2, LA 3, and LA 4 connected to the task devices. An LA group 2 includes task device 3 and task device 4, as well as access layer switches LA 5, LA 6, LA 7 and LA 8 connected to the task devices. The task device 1, task device 2, task device 3 and task device 4 collectively execute the same task.

In some embodiments, the LA may be configured with a plurality of ports, and each task device is connected to the LA through one of the ports. For a plurality of task devices in the same LA group, when the task devices need to exchange data with each other, the task devices may transmit a data packet by using the LA. The LA determines a forwarding path for the data packet based on a MAC address of a target task device and transfers the data packet to the target task device accurately. For example, with reference to FIG. 4, sub-FIGURE(a) shows a classification state of LA groups for four task devices. The task device 1 and the task device 2 belong to the LA group 1, and the task device 3 and the task device 4 belong to the LA group 2. Sub-FIGURE(b) of FIG. 4 shows a communication traffic ring formed by the four task devices. It is assumed that the task device 1 needs to send data to the task device 2, that is, the task device 2 is the target task device. First, the task device 1 may send a data packet to the LA 1. Then, the LA 1 forwards the received data packet to the task device 2. Alternatively, the task device 1 may select the LA 2 to forward the data packet, may select LA 3 to forward the data packet, or may select LA 4 to forward the data packet. This is not limited in the present disclosure.

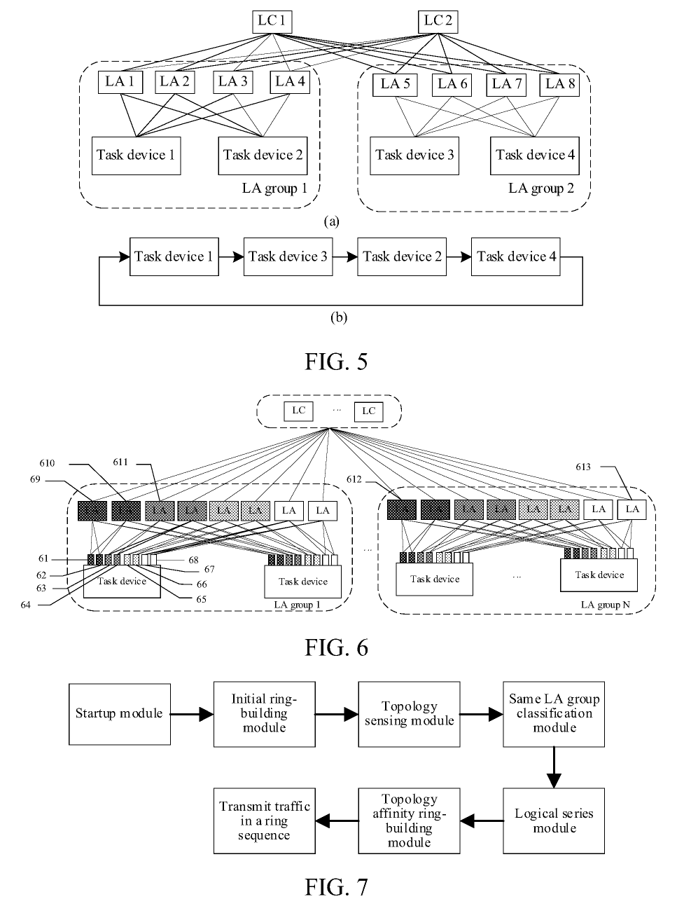

In some embodiments, for the plurality of task devices in different LA groups, when the task devices need to exchange data between each other, the task devices may transmit a data packet. Specifically, the LA first forwards the data packet sent by the task device to the LC connected to the LA. Then, the LC forwards the data packet to a target LA. The target LA may be determined based on the MAC address of the target task device in the data packet. Then, the target LA accurately transmits the data packet to the target task device through forwarding and routing functions, thereby implementing the data transmission between the task devices across the LA groups. The LC is located between the LA and a core-layer switch (SGLC), and a main function of the LC is to receive the data packet from the LA and transmit the data packet to the SGLC or another target device. In the present disclosure, the LC is configured to transmit the data packet from the LA to the target LA. For example, with reference to FIG. 5, sub-FIGURE(a) shows a classification state of LA groups for four task devices. Task device 1 and task device 2 belong to an LA group 1, and task device 3 and task device 4 belong to an LA group 2. Sub-FIGURE(b) of FIG. 5 shows a communication traffic ring formed by the four task devices. It is assumed that the task device 1 needs to send data to the task device 3, that is, the task device 3 is a target task device, and the task device 1 and the task device 3 belong to different LA groups. First, the task device 1 may send a data packet to an LA 1. Then, the LA 1 forwards the received data packet to an LC 2, and the LC 2 sends the received data packet to an LA 5. Finally, the LA 5 sends the data packet to the task device 3. Similarly, the LA 1 may be replaced with an LA 2, an LA 3, or an LA 4, the LC 2 may be replaced with an LC 1, and the LA 5 may be replaced with an LA 6, an LA 7 or an LA 8. This is not limited in the present disclosure.

In some embodiments, for communication between two task devices that are not directly connected in the communication traffic ring, data transmission between the two task devices that are not directly connected may be implemented by using an intermediate task device. For example, with reference to FIG. 4, it is assumed that the task device 1 needs to send the data to the task device 3, that is, the task device 3 is the target task device, the task device 1 and the task device 3 belong to different LA groups, and the task device 1 and the task device 3 are not directly connected in the communication traffic ring shown in FIG. 4. The task device 2 is the intermediate task device between the task device 1 and the task device 3. First, the task device 1 sends, by using the access layer switches (for example, the LA 1, LA 2, LA 3, or LA 4), the data to the task device 2 directly connected to the task device 1. Then, the task device 2 forwards, by using the access layer switches (for example, the LA 1, LA 2, LA 3, or LA 4) and the LC (for example, the LC 1 or LA 2), the data to the LA (for example, the LA 5, LA 6, LA 7, or LA 8) directly connected to the task device 3. Finally, the LA transmits the data to the task device 3.

According to the foregoing method, the communication between the task devices is performed by using the LA and the LC, so that efficient data transmission with a small delay can be implemented, and a faster and more stable communication environment can be provided, thereby supporting cooperative execution of the same task by the task devices.

In some embodiments, network segment information respectively corresponding to the N task devices is obtained, and the network segment information corresponds to the task device being configured to indicate a network address segment to which the task device belongs. The LA groups to which the N task devices belong respectively are determined based on the network segment information respectively corresponding to the N task devices. Task devices belong to the same network address segment being classified into the same LA group, and task devices belong to different network address segments being classified into different LA groups.

As shown in FIG. 4, network segment information respectively corresponding to the task device 1 and the task device 2 indicates the same network address segment, so that both the task device 1 and the task device 2 are classified into the LA group 1. Network segment information respectively corresponding to the task device 3 and the task device 4 indicates the same network address segment, so that both the task device 3 and the task device 4 are classified into the LA group 2.

The network address segment refers to a part of an internet protocol (IP) address, and is configured to divide address ranges of different networks. A network address segment may be determined based on an IP address and a subnet mask. Specifically, the IP address includes 32 binary digits, one part of the 32 binary digits being configured for representing a network address, and the other part being configured for representing a host address. The subnet mask is a 32-bit binary digit configured to identify division of the network address and the host address in the IP address. The network address may be obtained by applying the subnet mask to the IP address, and the network address is the foregoing network address segment. A main function of the network address segment is to classify the LA group to which the task device belongs in order to classify the task devices having the same network address segment into the same LA group. If network address segments of two task devices are the same, in other words, the two task devices have the same network address part and the two task devices belong to the same LA group.

According to the foregoing method, the task devices are classified into the corresponding LA group based on the network segment information, so that it is convenient to manage and control communication and data exchange between the task devices. The task devices in the same LA group can directly communicate with each other, and communication between task devices in different LA groups needs to be performed through forwarding by using the LC or another network device. In this way, network efficiency and security can be improved.

In some embodiments, for each of the N task devices, network segment information corresponding to a network interface card of the task device is obtained by invoking a communication library, and is used as network segment information corresponding to the task device, the network interface card of the task device being a hardware interface through which the task device communicates with an external network or another device, and the communication library being configured for providing a function and an interface that are related to network communication.

The network interface card is a computer hardware device, and is configured to implement a physical link between a computer device and a network. The network interface card is connected to the LA by using a network cable, and one LA may be connected to a plurality of network interface cards. The network communication can be performed between the task devices through connection between the network interface card and the LA in order to implement data transmission and the data exchange. In the network, when the task devices need to communicate with each other, the data packet needs to be sent to the LA by using the network interface card. Further, the LA sends the data packet to the target task device. If the target task device of the data packet is not in the same LA group, the LA may forward the data packet to an upper-layer device, which may be the LC. The LC may check the LA in which the target task device of the data packet is located, and then forward the data packet to the LA in which the target task device is located. The LA sends the data packet to the target task device.

That network segment information corresponding to a network interface card of the task device is obtained by invoking a communication library which refers to that information about the network interface card of the task device that is obtained by invoking the function or the interface provided in the communication library, including obtaining a name, a MAC address, an IP address, a subnet mask, and the like of the network interface card. Subsequently, the information may be used to calculate information about a network segment in which the task device is located, and the information is used as the network segment information corresponding to the task device.

A process in which the information about the network interface card of the task device is obtained by invoking the communication library is as follows: running a task on the task device and performing a method for invoking the communication library to obtain the information about the network interface card; obtaining the information about the network interface card, including obtaining the name, the MAC address, the IP address, the subnet mask, and the like of the network interface card; calculating, based on the obtained IP address and subnet mask, the information about the network segment in which the task device is located; using the calculated information about the network segment in which the task device is located as the network segment information of the task device for subsequent operations of the task devices, such as LA group classification.

According to the foregoing method, the network segment information corresponding to the N task devices is obtained by invoking the communication library, so that troublesome manual configuration can be avoided, and the network segment information of the task device can be automatically identified. Meanwhile, intelligent network management operations such as the LA group classification of the task devices and planning of a traffic transmission path can be performed based on the obtained network segment information, thereby improving efficiency and accuracy of network configuration.

In some embodiments, each task device is configured with a plurality of network interface cards, different network interface cards may access different LA ports, and different LAs have different network segment information. Therefore, the different network interface cards correspond to the different network segment information. For example, with reference to FIG. 6, each task device may be configured with eight network interface cards, which are respectively a network interface card 61, a network interface card 62, a network interface card 63, a network interface card 64, a network interface card 65, a network interface card 66, a network interface card 67, and a network interface card 68. For each LA in the same LA group, two LAs having the same grayscale value represent the same network segment information, and LAs having different grayscale values represent different network segment information. For example, network segment information of an LA 69 is the same as that of an LA 610, and the network segment information of the LA 69 is different from that of an LA 611. For LAs in different LA groups, the same grayscale value represents different network segment information, and different grayscale values also represent different network segment information. For example, the network segment information of the LA 69 is different from that of an LA 612, and the network segment information of LA 69 is different from that of an LA 613. The network interface card 61 and the network interface card 62 may be respectively connected to the LA 69 and the LA 610, and the network interface card 61 and the network interface card 62 respectively correspond to the same network segment information. Respective first network interface cards of the task devices belonging to the same LA group correspond to the same network segment information. Respective first network interface cards of the task devices belonging to different LA groups correspond to different network segment information.

In some embodiments, network segment information corresponding to a first network interface card of the task device is obtained based on a configuration parameter of the communication library, and is used as the network segment information corresponding to the task device. The first network interface card is one of a plurality of network interface cards of the task device, and the configuration parameter is configured to indicate the first network interface card in the plurality of network interface cards.

The first network interface card refers to any network interface card in the task device. For example, with reference to FIG. 6, the first network interface card may be any of the eight network interface cards.

The configuration parameter of the communication library is a group of parameters configured to specify behaviors and settings of the communication library. Specifically, the configuration parameter of the communication library includes a network interface card selection parameter, and the network interface card selection parameter is configured to indicate network segment information of the network interface card that is selected as the network segment information corresponding to the task device, in other words, configured to indicate the first network interface card in the plurality of network interface cards of the task device.

In some embodiments, the configuration parameter of the communication library may further include a security parameter, configured to set a security option of the communication library, such as an encryption algorithm, an identity authentication manner, and access control. The configuration parameter may further include a performance optimization parameter, configured to adjust performance and resource utilization of the communication library, such as a size of a buffer, a quantity of concurrent connections, and an expiration time.

According to the foregoing method, the network segment information corresponding to the first network interface card of the task device can be conveniently obtained by the configuration parameter of the communication library, and is used as the network segment information corresponding to the task device, thereby implementing more flexible and extensible network configuration.

In some embodiments, FIG. 7 is a flowchart of a method for planning a traffic transmission path according to another embodiment of the present disclosure. For each task device, after a startup module starts an artificial intelligence (AI) large model, the model invokes a ring-based algorithm of a communication library in order to enable a plurality of task devices to perform data synchronization and enable the task devices to enter an initial ring-building state. In an initial ring-building module, the communication library of the task device actively invokes information about a network interface card of the task device, and attempts to obtain network segment information of the task device. When a topology sensing module is entered and the N task devices perform an initial ring-building operation in the communication library, a bootstrap (guidance program) network organizes interaction of related information (for example, the network segment information) between the task devices. The bootstrap network is configured to support communication between the task devices, and the bootstrap network is a bridge for data interaction between the task devices. Specifically, the bootstrap network may collect network segment information of all the task devices using an AllGather (global collection) operation. For each of the task devices, LA group information of the task device and another task device can be obtained based on the network segment information of the task device and the another task device.

In some embodiments, in a cloud environment, due to factors such as virtualization and security, the communication library may not obtain the information about the network interface card of the task device. Therefore, network topology positioning cannot be directly performed by using the network segment information of the task device. To resolve this problem, hash values respectively corresponding to the N task devices may be obtained, and the LA groups to which the task devices belong are determined by using the hash values.

Specifically, the hash values respectively corresponding to the N task devices are obtained, the hash value corresponding to the task device being determined using a hash algorithm based on identification information of the task device; and the LA groups to which the N task devices belong respectively are determined based on the hash values respectively corresponding to the N task devices, task devices corresponding to the same hash value being classified into the same LA group, and task devices corresponding to different hash values being classified into different LA groups.

The hash value is a unique value calculated by using the hash algorithm based on the identification information of the task device. The hash algorithm is an algorithm that maps data of any size to a value of a fixed size. in some embodiments, the hash algorithm may be a message digest algorithm 5 (MD5), a secure hash algorithm 1 (SHA1), a secure hash algorithm 256-bit (SHA256), or the like. The identification information of the task device may be a unique identifier of the task device, such as a device identifier (ID), a MAC address, or an IP address.

During network topology positioning, the hash algorithm may be used to map the identification information of the task device to the hash value corresponding to the task device.

According to the foregoing method, the respective identification information of the N task devices is collected, and then the corresponding hash values are calculated using the hash algorithm. The task devices having the same hash value are classified into the same LA group, and the task devices having different hash values are classified into different LA groups. In this way, the task devices can be effectively grouped without relying on the network segment information of the task devices in order to implement the corresponding network topology positioning.

In some embodiments, for each of the N task devices, the hash value corresponding to the task device is obtained from a controller using a communication thread of the communication library. The controller is configured to manage and schedule communication information of the N task devices, and the communication library is configured to provide the function and the interface that are related to the network communication.

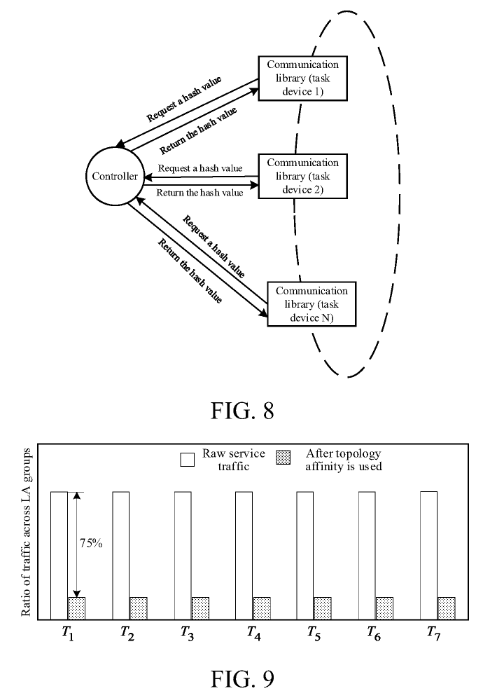

With reference to FIG. 8, each task device initiates a request using a communication thread of a communication library in order to request a controller to obtain a hash value corresponding to the task device. This may be implemented by an interface provided in the communication library. After receiving the request, the controller calculates, using a hash algorithm based on identification information (such as a device ID or an IP address) of the task device, the hash value corresponding to the task device. The controller returns the calculated hash value to the communication thread of the task device initiating the request.

The communication thread of the communication library refers to a thread running in the communication library, and is responsible for processing a communication operation of the task device. The controller refers to a component responsible for centrally managing and scheduling the communication information of the N task devices. The controller may perform hash calculation based on the identification information (such as the device ID or the IP address) of the task devices, so that grouping and positioning of the task devices are implemented, and communication between the task devices is managed and scheduled, thereby ensuring orderly cooperation of the task devices.

According to the foregoing method, the N task devices are centrally managed and scheduled by the controller in order to ensure that the communication between the task devices is sequential, efficient, and stable, and ensure secure transmission of data between the task devices. Meanwhile, the task devices are positioned by the hash algorithm, so that the task devices can be effectively classified into the corresponding LA groups, thereby improving efficiency and reliability of data transmission between the task devices. In addition, the task device can quickly and accurately obtain the hash value corresponding to the task device using the communication thread of the communication library in order to help implement topology sensing and organization of the task device, thereby further improving efficiency and quality of cooperation between the task devices.

In some embodiments, with reference to FIG. 7, in the topology sensing module, when the bootstrap network in the communication library is initialized, the communication thread obtains the hash value of the task device from the controller.

S320: Determine, based on the LA groups to which the N task devices belong respectively, a communication traffic ring formed by the N task devices, the communication traffic ring being a transmission path closed loop formed by sequentially connecting the N task devices communicatively, and task devices belonging to the same LA group being communicatively connected with each other in series within the communication traffic ring.

When the N task devices collectively execute an AI large model task, the AI large model usually invokes three types of collective communication primitives: AllReduce (global reduction), ReduceScatter (scattered reduction), and AllGather in order to synchronize and transmit data between the plurality of task devices. The AllReduce refers to an operation that reduces a to-be-reduced data value on each task device by using a specified reduction operation (such as adding or multiplying), and synchronously returns a reduction result to each task device. The AllReduce may be applied to calculation scenarios such as an aggregating model parameter and a loss calculation function, and can greatly improve a calculation speed. The ReduceScatter refers to an operation that reduces a to-be-reduced data value on each task device by using a specific reduction operation, and returns a reduction result to the plurality of task devices in a scattered manner. The ReduceScatter is usually configured to reduce global data to each task device for parallel processing. In the ReduceScatter, each task device receives only a part of reduction results of other task devices rather than all the reduction results. This helps reduce the load on a communication link and a delay of the data transmission, thereby improving communication efficiency. The AllGather refers to an operation that collects local data of each task device together to form a global view, and synchronously returns the local data to each task device. In an AllGather operation, each task device sends the local data of each task device to all task devices, and collects the local data of all task devices. Through the AllGather operation, the local data of each task device may be collected together to form the global view, and parallel calculation and processing are performed. The three types of collective communication primitives are implemented based on a ring-based structure. The N task devices form the communication traffic ring. The communication traffic ring determines a communication traffic transmission path between the N task devices. Different communication traffic transmission paths directly affect a volume of traffic across the LA groups, and as a result, the communication efficiency is affected.

Specifically, to synchronize and transmit data of the large model, the data transmission needs to be performed between the plurality of task devices using the collective communication primitives. The collective communication primitives implemented based on the ring-based structure connects the N task devices to form the communication traffic ring, thereby forming a data communication path between the task devices. Different task devices may belong to different LA groups, and as a result, a case in which data is transmitted across the LA groups is caused. If an amount of data transmitted across the groups is large, a communication delay and a bandwidth pressure are increased, and the communication efficiency is reduced. Therefore, how to construct a proper communication traffic ring becomes a key to optimize performance of the collective communication primitives.

In some embodiments, with reference to FIG. 7, in the same LA group classification module, the task devices belonging to the same LA group are classified into the same task device group and the task devices belonging to different LA groups are classified into different task device groups (where the division rule may also be referred to as a principle that task devices in the same LA group are classified into the same group) based on the LA groups to which the N task devices belong respectively in order to obtain M groups of task devices, and M is an integer greater than one. In a logical series module, for each of the M groups of task devices, task devices included in the group are communicatively connected with each other in series in order to obtain task device chains. In a topology affinity ring-building module, M task device chains are sequentially connected communicatively in order to obtain the communication traffic ring formed by the N task devices. Finally, when the N task devices communicate with each other, the traffic is transmitted in a ring sequence.

The task device chain refers to a manner that defines a sequence and a direction of the data transmission between the task devices. The task device chain may be configured to specify data sending and receiving directions and a data transmission path. A task device chain [task device A-> task device D] means that the task device A sends data, and the task device D receives the data.

Any task device may obtain topology position information of another task device. For each task device, the obtained information may include: [task device A: LA group 1, task device B: LA group 2, task device C: LA group 2, task device D: LA group 1, and task device E: LA group 3]. The task devices in the same LA group are clustered, based on the foregoing information, and the N task devices are classified into three groups of task devices. The three groups of task devices may be the LA group 1: [task device A, task device D], the LA group 2: [task device B, task device C], and the LA group 3: [task device E].

In some embodiments, the task devices respectively included in the M groups of task devices are connected in series based on the foregoing information in order to obtain the M task device chains. In these task device chains, relative positions of the task devices in each group may be arranged in a plurality of manners. This is not limited in the present disclosure. For example, in a ring-building process of the communication library, devices in the same LA group are logically connected in series. For example, for the LA group 1 in the foregoing example, the task device chain may be [task device A-> task device D], or may be [task device D-> task device A]. For the LA group 2 in the foregoing example, the task device chain may be [task device B-> task device C], or may be [task device C-> task device B]. Setting of the task device chain may be flexibly configured based on a specific requirement and a system architecture. An appropriate task device chain may be determined based on different positions and traffic transmission paths between the task devices. The data transmission path and direction can be optimized, and the communication efficiency and performance can be improved by setting the appropriate task device chain.

In some embodiments, the relative positions of the task devices in each group are arranged in different manners, and the traffic transmission paths are also different. The task device chain [task device A-> task device D] means that the task device A sends the data, and the task device D receives the data. The task device chain [task device D-> task device A] means that the task device D sends the data, and the task device A receives the data.

In some embodiments, the M task device chains are sequentially connected communicatively in order to obtain the communication traffic ring formed by the N task devices. The M task device chains may be arranged in the plurality of manners to obtain different communication traffic rings. This is not limited in the present disclosure. For the task device chain [task device A-> task device D], the task device chain [task device B-> task device C], and the task device chain [task device E], the communication traffic ring may be [task device A-> task device D-> task device B-> task device C-> task device E-> task device A], or may be [task device A-> task device D-> task device E-> task device B-> task device C-> task device A]. For the task device chain [task device D-> task device A], the task device chain [task device C-> task device B], and the task device chain [task device E], the communication traffic ring may be [task device D-> task device A-> task device C-> task device B-> task device E-> task device D], or may be [task device D-> task device A-> task device E-> task device C-> task device B-> task device D]. This is not limited in the present disclosure. Therefore, in the present disclosure, the M task device chains are allowed to be connected in a plurality of different arrangement manners in order to form the communication traffic ring formed by the N task devices. This flexibility enables the technical solution to adapt to different network topologies and environment requirements, and provides more efficient communication transmission. In an implementation process, an appropriate arrangement manner of the task device chains may be selected based on a specific requirement in order to satisfy communication requirements in different scenarios.

In some embodiments, if the network segment information of the N task devices is obtained, the N task devices may alternatively be classified into the M groups of task devices based on the network segment information respectively corresponding to the N task devices and a principle that alternatively having the same network segment information are classified into the same group. For example, for each task device, the obtained information may be [task device A: network segment 1, task device B: network segment 2, task device C: network segment 2, task device D: network segment 1, and task device E: network segment 3]. The task devices in the same network segment are clustered based on the foregoing information, and the N task devices are classified into three groups of task devices. The network segment 1: [device A, device D], the network segment 2: [device B, device C], and the network segment 3: [device E]. A manner of classifying the N task devices into the M groups of task devices is not limited in the present disclosure. The N task devices may be classified based on the LA groups of the N task devices, or may be classified based on the network segment information of the N task devices, and the classification manner may be flexibly adjusted based on a specific requirement and scenario.

According to the foregoing method, the communication between the N task devices can be effectively managed and optimized. This organization manner enables the communication traffic to be transmitted in the same LA group as much as possible, thereby reducing the traffic across the LA groups, and further improving the communication efficiency and reliability.

In some embodiments, the technical solutions provided in the present disclosure can greatly reduce the traffic across the LA groups. For example, as shown in FIG. 5, when a sequence of the communication traffic ring formed by the task devices is: [task device 1-> task device 3-> task device 2-> task device 4-> task device 1], specifically, when the task device 1 communicates with the task device 3, the task device 1 and the task device 3 belong to different LA groups. Therefore, the traffic needs to be transmitted across the LA groups. For example, the LA 1, LC 1, and LA 5 may be selected to forward the traffic. When the task device 3 communicates with the task device 2, the task device 3 and the task device 2 belong to different LA groups. Therefore, the traffic needs to be transmitted across the LA groups. For example, the LA 5, LC 2, and LA 4 may be selected to forward the traffic. When the task device 2 communicates with the task device 4, the task device 2 and the task device 4 belong to different LA groups. Therefore, the traffic needs to be transmitted across the LA groups. For example, the LA 2, LC 2, and LA 6 may be selected to forward traffic. When the task device 4 communicates with the task device 1, the task device 4 and the task device 1 belong to different LA groups. Therefore, the traffic needs to be transmitted across the LA groups. For example, the LA 6, LC 2, and LA 4 may be selected to forward the traffic. Therefore, according to the foregoing communication traffic ring, the traffic crosses the LA groups for four times, and the traffic is limited in the LA group for zero time, in other words, traffic communication is performed across the LA groups each time. An indicator may be determined to measure a quality of the communication traffic ring, that is, traffic topology affinity is equal to the quantity of times that real traffic is limited in the LA group or the traffic is limited to a maximum quantity of times in the LA group theoretically. The communication traffic ring shown in FIG. 4 has a traffic topology affinity of 0/2 = 0.

According to the technical solutions provided in the present disclosure, topology affinity is planned on the four task devices. As shown in FIG. 5, the sequence of the ring formed by the task devices is changed into: [task device 1-> task device 2-> task device 3-> task device 4-> task device 1]. When the task device 1 communicates with the task device 2, the task device 1 and the task device 2 belong to the same LA group. Therefore, the traffic does not need to be transmitted across the LA groups. For example, the LA 1 may be selected to forward the traffic. When the task device 2 communicates with the task device 3, the task device 2 and the task device 3 belong to different LA groups. Therefore, the traffic needs to be transmitted across the LA groups. For example, the LA 1, LC 1, and LA 5 may be selected to forward the traffic. When the task device 3 communicates with the task device 4, the task device 3 and the task device 4 belong to the same LA group. Therefore, the traffic does not need to be transmitted across the LA groups. For example, the LA 5 may be selected to forward the traffic. When the task device 4 communicates with the task device 1, the task device 4 and the task device 1 belong to different LA groups. Therefore, the traffic needs to be transmitted across the LA groups. For example, the LA 8, LC 1, and LA 4 may be selected to forward the traffic. Therefore, according to the communication traffic ring, the traffic crosses the LA groups for two times, and the traffic is limited in the LA group for zero time. In comparison with FIG. 4, the traffic across the LA groups is reduced by 50%, and the traffic topology affinity is 2/2 = 100%, so that optimal topology affinity is achieved.

In some embodiments, the technical solutions provided in the present disclosure reduces the traffic across the LA groups. FIG. 9 shows measurement data. A horizontal coordinate represents time, and a vertical coordinate represents a ratio of the traffic across the LA groups. When an artificial intelligence (AI) large model task is run in AllReduce (ring) in a communication library 1, the traffic across the LA groups is 91%. The AllReduce (ring) is a collective communication primitive using a ring topology structure, and is configured to implement data synchronization and transmission between a plurality of task devices. The task devices may perform a reduce operation on data of the task devices using the communication primitive, and then transmit a result to another task device through a ring path. However, without optimization, a large amount of data transmitted across the LA groups may cause a high communication delay and a bandwidth pressure. To resolve this problem, the present disclosure provides a topology affinity technical solution. A connection relationship between the task devices is optimized using a communication library 2, thereby reducing the traffic transmission across the LA groups. In an actual test, this technical solution reduces the traffic across the LA groups by 75%. The communication library 1 and the communication library 2 are open-source communication libraries that can be obtained.

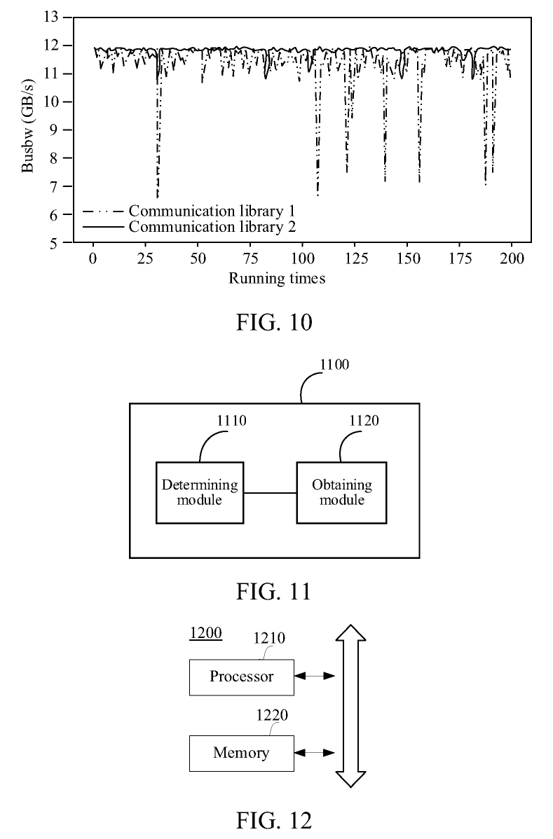

In some embodiments, a comparison test is performed in the present disclosure in order to evaluate performance of the technical solution provided in the present disclosure on AllReduce performance and prove stronger stability of the technical solution. The AllReduce is a collective communication operation in parallel calculation, and is configured to perform the reduce operation on the data in the plurality of task devices and distribute the result to all the task devices. The AllReduce is configured to implement a global reduce operation in the parallel calculation, such as summation or calculation of an average value. FIG. 10 shows a test result, a horizontal coordinate representing a quantity of running times, and a vertical coordinate representing a bus bandwidth. A testing environment is a cloud environment, a single network interface card and four task devices are used, and a long-term stability test is performed between the communication library 1 and the communication library 2 for 200 times. It may be learned based on data in the figure that a bus bandwidth of the communication library 1 has large fluctuations, and a bandwidth of the communication library 2 is nearly stable and almost has no jitter. This is because the communication library 2 in the technical solution provided in the present disclosure uses a topological affinity feature to put communication traffic in the same LA group as much as possible, thereby reducing a probability of load imbalance. The load imbalance may cause an excessively large amount of data processed by some task devices, but other task devices are in an idle state. As a result, overall communication performance and efficiency are affected. The communication library 2 successfully reduces the data transmission across the LA groups by optimizing a communication path between the task devices, so that the communication traffic is more evenly distributed in the LA groups. Such an optimized design enables the communication library 2 to have more stable performance of the bus bandwidth in an AllReduce process, so that a communication delay is reduced, thereby improving data transmission efficiency between the task devices. Therefore, based on the technical solution provided in the present disclosure, a comparison test result indicates that the communication library 2 has stronger stability, and can effectively reduce a load imbalance problem and optimize utilization of the bus bandwidth, thereby improving performance and overall communication efficiency of the AllReduce.

In some embodiments, in the technical solution provided in the present disclosure, a method for reducing a probability of a hash collision is used to improve the performance. During training of a large model task, because there is no topology affinity condition, the load imbalance exists on a link. A significant performance improvement is achieved by introducing a related optimization measure at a communication layer. Specifically, a performance indicator test is performed on the large model task at the communication layer. When a link with the load imbalance is not bypassed by using the topology affinity, a measured bandwidth of a 4G message of the task is 87.51 GB/s However, through the technical solution, after the link with the load imbalance is bypassed by using the topology affinity, the bandwidth is improved to 140.71 GB/s, which is improved by nearly 60%. This means that a data transmission rate is significantly improved by reducing a load imbalance phenomenon of the link. In addition to the performance improvement at the communication layer, the technical solution further improves a performance indicator for the task. After optimization, a sample transmission rate is increased by 11.4%. Through this improvement, task data can be processed more efficiently.

In some embodiments, the technical solution provided in the present disclosure allows a network architect to limit traffic in the LA group as much as possible. When the traffic is transmitted inside the LA group, due to a localization feature, an LA convergence ratio can be improved. The local area convergence ratio refers to the proportion of traffic, within a specific network area in the LA group, is transmitted and distributed inside the area within the LA group. The traffic is limited to be transmitted in a small area within the LA group, so that a requirement for transmission across the areas can be reduced, and a delay and resource consumption caused by communication across the areas within the LA groups can be reduced. Quantities of constructed LCs and SGLCs can be reduced by increasing the LA convergence ratio, thereby reducing costs.

According to the technical solution provided in the present disclosure, in a process of constructing a communication traffic ring, relative communication positions of N task devices are properly planned based on the LA groups to which the N task devices belong respectively, the task devices belonging to the same LA group are communicatively connected with each other in series, and then a closed-loop transmission path is formed by the N task devices as a final communication traffic ring. According to the foregoing method, because the devices in the same LA group are communicatively connected with each other in series, when traffic transmission is performed, the unnecessary traffic transmission across the LA groups can be avoided, thereby reducing traffic across the LA groups, and improving communication efficiency between the task devices.

The following describes an apparatus embodiment in the present disclosure, which can be configured to implement the method embodiment of the present disclosure. For details not disclosed in the apparatus embodiment in the present disclosure, refer to the method embodiment of the present disclosure.

FIG. 11 is a block diagram of an apparatus for planning a traffic transmission path according to an embodiment of the present disclosure The apparatus has a function for implementing the foregoing method for planning a traffic transmission path. The function may be implemented by hardware, or may be implemented by hardware executing corresponding software. The apparatus may be a computer device, or may be disposed in the computer device. The apparatus 1100 may include: a determining module or a determining code 1110, and an obtaining module or an obtaining code 1120.

The determining module 1110 is configured to determine access layer switch (LA) groups to which N task devices belong respectively, each of the LA groups including at least one of the task devices and an LA connected to the at least one of the task devices, the N task devices belonging to at least two LA groups, the N task devices collectively executing the same task, and N being an integer greater than one.

The obtaining module 1120 is configured to determine, based on the LA groups to which the N task devices belong respectively, a communication traffic ring formed by the N task devices, the communication traffic ring being a closed-loop transmission path formed by sequentially connecting the N task devices communicatively, and task devices belonging to the same LA group being communicatively connected with each other in series within the communication traffic ring.

In some embodiments, the determining module 1110 includes a first obtaining unit and a first determining unit (not shown in FIG. 11).

The first obtaining unit is configured to obtain network segment information respectively corresponding to the N task devices, the network segment information corresponding to the task device being used to indicate a network address segment to which the task device belongs.

The first determining unit is configured to determine, based on the network segment information respectively corresponding to the N task devices, the LA groups to which the N task devices belong respectively, task devices belonging to the same network address segment being classified into the same LA group, and task devices belonging to different network address segments being classified into different LA groups.

In some embodiments, the first obtaining unit is specifically configured to: for each of the N task devices, obtain network segment information corresponding to a network interface card of the task device by invoking a communication library, as the network segment information corresponding to the task device, the network interface card of the task device being a hardware interface through which the task device communicates with an external network or another device, and the communication library being configured to provide a function and an interface that are related to network communication.

In some embodiments, the first obtaining unit is specifically configured to: obtain network segment information corresponding to a first network interface card of the task device based on a configuration parameter of the communication library, as the network segment information corresponding to the task device, the first network interface card of the task device being one of a plurality of network interface cards of the task device, and the configuration parameter being configured to indicate the first network interface card in the plurality of network interface cards.

In some embodiments, the determining module 1120 includes a second obtaining unit and a second determining unit (not shown in FIG. 11).

The second obtaining unit is configured to obtain hash values respectively corresponding to the N task devices, and the hash value corresponds to the task device being determined by using a hash algorithm based on identification information of the task device.

The second determining unit is configured to determine, based on the hash values respectively corresponding to the N task devices, the LA groups to which the N task devices belong respectively, task devices corresponding to the same hash value being classified into the same LA group, and task devices corresponding to different hash values being classified into different LA groups.

In some embodiments, the second obtaining unit is specifically configured to: for each of the N task devices, obtain the hash value corresponding to the task device from a controller through a communication thread of the communication library, the controller being configured to manage and schedule communication information of the N task devices, and the communication library being configured to provide the function and the interface that are related to the network communication.

In some embodiments, the obtaining module 1120 is specifically configured to: classify the task devices belonging to the same LA group into the same task device group, and classify, based on the LA groups to which the N task devices belong respectively, the task devices belonging to different LA groups into different task device groups in order to obtain M groups of task devices, and M being an integer greater than one; for each of the M groups of task devices, communicatively connect task devices included in the group with each other in series in order to obtain M task device chains; and the M task device chains are sequentially connected communicatively in order to obtain the communication traffic ring.

According to the technical solution provided in the present disclosure, in a process of constructing the communication traffic ring, relative communication positions of the N task devices are properly planned based on the LA groups to which the N task devices belong respectively, the task devices belonging to the same LA group are communicatively connected with each other in series, and then the transmission path closed loop is formed by the N task devices as a final communication traffic ring. According to the foregoing method, because the devices in the same LA group are communicatively connected with each other in series, when traffic transmission is performed, the unnecessary traffic transmission across the LA groups can be avoided, thereby reducing traffic across the LA groups, and improving communication efficiency between the task devices.

When the apparatus provided in the foregoing embodiment implements its functions, only divisions of the foregoing functional modules are described using an example. During an actual application, the foregoing functions may be allocated to and completed by different functional modules as required, in other words, an internal structure of the apparatus is divided into different functional modules in order to complete all or some of the foregoing described functions. In addition, the apparatus and the method provided in the foregoing embodiments belong to the same concept. For a specific implementation process, refer to the method embodiment. Details are not described herein.

FIG. 12 is a block diagram of a structure of a computer device 1200 according to an embodiment of the present disclosure.

Generally, the computer device 1200 includes a processor 1210 and a memory 1220.

The processor 1210 may include one or more processing cores, for example, a 4-core processor or an 8-core processor. The processor 1210 may be implemented by using at least one hardware form of digital signal processing (DSP), a field programmable gate array (FPGA), or a programmable logic array (PLC). The processor 1210 may further include a main processor and a co-processor. The main processor is a processor configured to process data in a wakeup state, and is also referred to as a central processing unit (CPU). The co-processor is a low-power processor configured to process data in a standby state. In some embodiments, the processor 1210 may be integrated with a graphics processing unit (GPU). The GPU is configured to be responsible for rendering and drawing content that needs to be displayed on a display screen. In some embodiments, the processor 1210 may further include an AI processor. The AI processor is configured to process a calculation operation related to machine learning.

The memory 1220 may include one or more computer-readable storage media, and the computer-readable storage media may be non-transitory. The memory 1220 may further include a high-speed random access memory, and a non-volatile memory such as one or more magnetic disk storage devices and flash storage devices. In some embodiments, the non-transitory computer-readable storage medium in the memory 1220 is configured to store a computer program, the computer program being configured to be executed by one or more processors, to implement the foregoing method for planning a traffic transmission path.

A person skilled in the art may understand that the structure shown in FIG. 12 does not constitute a limitation to the computer device 1200, and the computer device 1200 may include more components or fewer components than those shown in the figure, or some components may be combined, or a different component deployment may be used.

In some embodiments, a computer-readable storage medium is further provided, the storage medium having the computer program stored therein, and the computer program being loaded and executed by the processor to implement the foregoing method for planning a traffic transmission path.

In some embodiments, the computer-readable storage medium may include: a read-only memory (ROM), a random access memory (RAM), a solid state drive (SSD), an optical disc, or the like. The random access memory may include a resistance random access memory (ReRAM) and a dynamic random access memory (DRAM).

In some embodiments, a computer program product is further provided, the computer program product including the computer program, the computer-readable storage medium having the computer program stored therein, and the processor reading and executing the computer program from the computer-readable storage medium in order to implement the foregoing method for planning a traffic transmission path.

The "plurality of" mentioned in this specification means two or more. The "and/or" describes an association relationship for describing associated objects and represents that three relationships may exist. For example, A and/or B may represent the following three cases: only A exists, both A and B exist, and only B exists. The character "/" generally represents an "or" relationship between the associated objects. In addition, operation numbering described in this specification merely shows a possible sequence of performing the operations. In some other embodiments, the foregoing operations may not be performed based on the numbering sequence. For example, two different numbered operations are performed simultaneously, or two different numbered operations are performed based on a sequence reverse to that shown in the figure. This is not limited in the embodiments of the present disclosure.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A method for planning a traffic transmission path, the method comprising:
determining access layer switch (LA) groups to which N task devices belong respectively,
each of the LA groups comprising at least one of the task devices and an LA connected to the at least one of the task devices,
the N task devices belonging to at least two LA groups,
the N task devices collectively executing the same task, and
N being an integer greater than one; and
determining, based on the LA groups to which the N task devices belong respectively, a communication traffic ring formed by the N task devices,
the communication traffic ring being a closed-loop transmission path formed by sequentially connecting the N task devices communicatively, and
task devices belonging to the same LA group being communicatively connected with each other in series within the communication traffic ring.

2. The method according to claim 1, wherein the determining LA groups to which N task devices belong respectively comprises:
obtaining network segment information respectively corresponding to the N task devices, the network segment information corresponding to a task device of the N task devices being configured to indicate a network address segment to which the task device belongs; and
determining, based on the network segment information respectively corresponding to the N task devices, the LA groups to which the N task devices belong respectively, task devices belonging to the same network address segment being classified into the same LA group, and task devices belonging to different network address segments being classified into different LA groups.

3. The method according to claim 2, wherein the obtaining network segment information respectively corresponding to the N task devices comprises:
for each of the N task devices, obtaining, by invoking a communication library, network segment information corresponding to a network interface card of the task device, and
using the network segment information as network segment information corresponding to the task device;
the network interface card of the task device being a hardware interface through which the task device communicates with an external network or another task device, and
the communication library being configured to provide a function and an interface that are related to network communication.

4. The method according to claim 3, wherein the obtaining, by invoking the communication library, network segment information corresponding to a network interface card of the task device, and using the network segment information as network segment information corresponding to the task device comprises:
obtaining, based on a configuration parameter of the communication library, network segment information corresponding to a first network interface card of the task device, and using the network segment information as the network segment information corresponding to the task device;
the first network interface card of the task device being one of a plurality of network interface cards of the task device, and the configuration parameter being configured to indicate the first network interface card in the plurality of network interface cards.

5. The method according to claim 2, wherein the determining LA groups to which N task devices belong respectively comprises:
obtaining hash values respectively corresponding to the N task devices, a hash value of the hash values corresponding to the task device being determined using a hash algorithm based on identification information of the task device; and
determining, based on the hash values respectively corresponding to the N task devices, the LA groups to which the N task devices belong respectively, task devices corresponding to the same hash value being classified into the same LA group, and task devices corresponding to different hash values being classified into different LA groups.

6. The method according to claim 5, wherein the obtaining hash values respectively corresponding to the N task devices comprises:
for each of the N task devices, obtaining, from a controller using a communication thread of the communication library, the hash value corresponding to the task device;
the controller being configured to manage and schedule communication information of the N task devices, and the communication library being configured to provide the function and the interface that are related to the network communication.

7. The method according to claim 2, wherein the determining, based on the LA groups to which the N task devices belong respectively, the communication traffic ring formed by the N task devices comprises:
classifying the task devices belonging to the same LA group into the same task device group and classifying the task devices belonging to different LA groups into different task device groups based on the LA groups to which the N task devices belong respectively to obtain M groups of task devices, M being an integer greater than one;
for each of the M groups of task devices, communicatively connecting task devices comprised in the group with each other in series to obtain task device chains; and
sequentially connecting M task device chains communicatively to obtain the communication traffic ring.

8. An apparatus for planning a traffic transmission path, the apparatus comprising:
at least one memory configured to store program code; and
at least one processor configured to read the program code and operate as instructed by the program code, the program code comprising:
a first determining code configured to cause at least one of the at least one processor determine access layer switch (LA) groups to which N task devices belong respectively,
each of the LA groups comprising at least one of the task devices and an LA connected to the at least one of the task devices,
the N task devices belonging to at least two LA groups,
the N task devices collectively executing the same task, and
N being an integer greater than one; and
a first obtaining code configured to cause at least one of the at least one processor determine, based on the LA groups to which the N task devices belong respectively, a communication traffic ring formed by the N task devices,
the communication traffic ring being a closed-loop transmission path formed by sequentially connecting the N task devices communicatively, and
task devices belonging to the same LA group being communicatively connected with each other in series within the communication traffic ring.

9. The apparatus according to claim 8, wherein the program code further comprises:
a second obtaining code configured to cause at least one of the at least one processor to obtain network segment information respectively corresponding to the N task devices, the network segment information corresponding to a task device of the N task devices being configured to indicate a network address segment to which the task device belongs; and
a second determining code configured to cause at least one of the at least one processor to determine, based on the network segment information respectively corresponding to the N task devices, the LA groups to which the N task devices belong respectively, task devices belonging to the same network address segment being classified into the same LA group, and task devices belonging to different network address segments being classified into different LA groups.

10. The apparatus according to claim 9, wherein the program code further comprises:
a third obtaining code configured to cause at least one of the at least one processor to, for each of the N task devices, obtain, by invoking a communication library, network segment information corresponding to a network interface card of the task device, and
a first use code configured to cause at least one of the at least one processor to use the network segment information as network segment information corresponding to the task device;
the network interface card of the task device being a hardware interface through which the task device communicates with an external network or another task device, and
the communication library being configured to provide a function and an interface that are related to network communication.

11. The apparatus according to claim 10, wherein the program code further comprises:
a fourth obtaining code configured to cause at least one of the at least one processor to obtain, based on a configuration parameter of the communication library, network segment information corresponding to a first network interface card of the task device, and
a second use code configured to cause at least one of the at least one processor to use the network segment information as the network segment information corresponding to the task device;
the first network interface card of the task device being one of a plurality of network interface cards of the task device, and the configuration parameter being configured to indicate the first network interface card in the plurality of network interface cards.

12. The apparatus according to claim 10, wherein the program code further comprises:
a fifth obtaining code configured to cause at least one of the at least one processor to obtain hash values respectively corresponding to the N task devices, a hash value of the hash values corresponding to the task device being determined using a hash algorithm based on identification information of the task device; and
a third determining code configured to cause at least one of the at least one processor to determine, based on the hash values respectively corresponding to the N task devices, the LA groups to which the N task devices belong respectively, task devices corresponding to the same hash value being classified into the same LA group, and task devices corresponding to different hash values being classified into different LA groups.

13. The apparatus according to claim 12, wherein the program code further comprises:
a sixth obtaining code configured to cause at least one of the at least one processor to, for each of the N task devices, obtain, from a controller using a communication thread of the communication library, the hash value corresponding to the task device;
the controller being configured to manage and schedule communication information of the N task devices, and the communication library being configured to provide the function and the interface that are related to the network communication.

14. The apparatus according to claim 12, wherein the program code further comprises:
a classifying code configured to cause at least one of the at least one processor to classify the task devices belonging to the same LA group into the same task device group and classifying the task devices belonging to different LA groups into different task device groups based on the LA groups to which the N task devices belong respectively to obtain M groups of task devices, M being an integer greater than one;
a first connecting code configured to cause at least one of the at least one processor to, for each of the M groups of task devices, communicatively connecting task devices comprised in the group with each other in series to obtain task device chains; and
a second connecting code configured to cause at least one of the at least one processor to sequentially connecting M task device chains communicatively to obtain the communication traffic ring.

15. A non-transitory computer-readable storage medium, storing computer code which, when executed by at least one processor, causes the at least one processor to at least:
determine access layer switch (LA) groups to which N task devices belong respectively,
each of the LA groups comprising at least one of the task devices and an LA connected to the at least one of the task devices,
the N task devices belonging to at least two LA groups,
the N task devices collectively executing the same task, and
N being an integer greater than one; and
determine, based on the LA groups to which the N task devices belong respectively, a communication traffic ring formed by the N task devices,
the communication traffic ring being a closed-loop transmission path formed by sequentially connecting the N task devices communicatively, and
task devices belonging to the same LA group being communicatively connected with each other in series within the communication traffic ring.

16. The non-transitory computer-readable storage medium according to claim 15, wherein the determining LA groups to which N task devices belong respectively comprises:
obtaining network segment information respectively corresponding to the N task devices, the network segment information corresponding to a task device of the N task devices being configured to indicate a network address segment to which the task device belongs; and
determining, based on the network segment information respectively corresponding to the N task devices, the LA groups to which the N task devices belong respectively, task devices belonging to the same network address segment being classified into the same LA group, and task devices belonging to different network address segments being classified into different LA groups.

17. The non-transitory computer-readable storage medium according to claim 16, wherein the obtaining network segment information respectively corresponding to the N task devices comprises:
for each of the N task devices, obtaining, by invoking a communication library, network segment information corresponding to a network interface card of the task device, and
using the network segment information as network segment information corresponding to the task device;
the network interface card of the task device being a hardware interface through which the task device communicates with an external network or another task device, and
the communication library being configured to provide a function and an interface that are related to network communication.

18. The non-transitory computer-readable storage medium according to claim 17, wherein the obtaining, by invoking the communication library, network segment information corresponding to a network interface card of the task device, and using the network segment information as network segment information corresponding to the task device comprises:
obtaining, based on a configuration parameter of the communication library, network segment information corresponding to a first network interface card of the task device, and using the network segment information as the network segment information corresponding to the task device;
the first network interface card of the task device being one of a plurality of network interface cards of the task device, and the configuration parameter being configured to indicate the first network interface card in the plurality of network interface cards.

19. The non-transitory computer-readable storage medium according to claim 16, wherein the determining LA groups to which N task devices belong respectively comprises:
obtaining hash values respectively corresponding to the N task devices, a hash value of the hash values corresponding to the task device being determined using a hash algorithm based on identification information of the task device; and
determining, based on the hash values respectively corresponding to the N task devices, the LA groups to which the N task devices belong respectively, task devices corresponding to the same hash value being classified into the same LA group, and task devices corresponding to different hash values being classified into different LA groups.

20. The non-transitory computer-readable storage medium according to claim 19, wherein the obtaining hash values respectively corresponding to the N task devices comprises:
for each of the N task devices, obtaining, from a controller using a communication thread of the communication library, the hash value corresponding to the task device, the controller being configured to manage and schedule communication information of the N task devices, and the communication library being configured to provide the function and the interface that are related to the network communication.
